(19) United States
(12) Patent Application Publication
(10) Pub. No.: US 2026/0323353 A1
(43) Pub. Date: Oct. 15, 2026

(54) Enhancements to Group-Based Reporting for Multiple Receive Chain Reception

(71) Applicant: Apple Inc., Cupertino, CA (US)

(72) Inventors: Manasa RAGHAVAN, Sunnyvale, CA (US); Haitong SUN, Saratoga, CA (US); Jie CUI, San Jose, CA (US); Xiang CHEN, Palo Alto, CA (US); Yang TANG, San Jose, CA (US); Yuexia SONG, Beijing (CN)

(21) Appl. No.: 19/482,931

(22) PCT Filed: May 10, 2023
(86) PCT No.: PCT/CN2023/093198

§ 371 Date: Nov. 10, 2025

(51) Int. Cl. H04W 24/10; H04B 7/06; H04B 17/309; H04B 17/318

(52) U.S. Cl. CPC H04W 24/10; H04B 7/0626; H04B 17/328; H04B 17/346

(57) ABSTRACT

A base station configured to transmit configuration information to a user equipment (UE), wherein the UE is configured to receive a first beam from a first transmission and reception point (TRP) and a second beam from a second TRP, and wherein the first TRP is a serving cell and the second TRP is a cell with a different physical cell identifier (PCI) than the serving cell, the configuration information comprising enablement information configured to enable the UE to perform group-based beam reporting for both the serving cell and the cell with the different PCI and receive a group-based beam report from the UE, wherein the group-based beam report comprises measurement information for the cell with the different PCI.

### TECHNICAL FIELD

This application relates generally to wireless communication systems, and in particular relates to enhancements to Group-Based reporting for multiple receive chain reception.

### BACKGROUND INFORMATION

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (WCDMA, TDS-CDMA), LTE, LTE Advanced (LTE-A), HSPA, 3GPP2 CDMA2000 (e.g., 1xRTT, 1xEV-DO, HRPD, eHRPD), IEEE 802.11 (WLAN or Wi-Fi), IEEE 802.16 (WiMAX), BLUETOOTH™, etc. A current telecommunications standard moving beyond previous standards is called 5th generation mobile networks or 5th generation wireless systems, referred to as 3GPP NR (otherwise known as 5G-NR or NR-5G for 5G New Radio, also simply referred to as NR). NR proposes a higher capacity for a higher density of mobile broadband users, also supporting device-to-device, ultra-reliable, and massive machine communications, as well as lower latency and lower battery consumption, than LTE standards.

One aspect of wireless communication systems, including NR cellular wireless communications, is radio resource management (RRM), which includes physical layer (Layer 1, L1) measurement and reporting of various channel and communication metrics. Continued development calls for improvements and support for group-based beam reporting, in particular in situations with simultaneous multi-receive-chain (multi-RX chain) reception and inter-cell beam management where a user equipment (UE) may have a serving cell and a cell with a different or additional Physical Cell ID (PCI).

### SUMMARY

Some exemplary embodiments are related to a method for wireless communications performed by a base station. The method including transmitting configuration information to a user equipment (UE), wherein the UE is configured to receive a first beam from a first transmission and reception point (TRP) and a second beam from a second TRP, and wherein the first TRP is a serving cell and the second TRP is a cell with a different physical cell identifier (PCI) than the serving cell, the configuration information comprising enablement information configured to enable the UE to perform group-based beam reporting for both the serving cell and the cell with the different PCI and receiving a group-based beam report from the UE, wherein the group-based beam report comprises measurement information for the cell with the different PCI.

Other exemplary embodiments are related to a processor of a base station configured to transmit configuration information to a user equipment (UE), wherein the UE is configured to receive a first beam from a first transmission and reception point (TRP) and a second beam from a second TRP, and wherein the first TRP is a serving cell and the second TRP is a cell with a different physical cell identifier (PCI) than the serving cell, the configuration information comprising enablement information configured to enable the UE to perform group-based beam reporting for both the serving cell and the cell with the different PCI and receive a group-based beam report from the UE, wherein the group-based beam report comprises measurement information for the cell with the different PCI.

Still further exemplary embodiments are related to a method for wireless communications performed by a user equipment (UE) configured to receive a first beam from a first transmission and reception point (TRP) and a second beam from a second TRP, wherein the first TRP is a serving cell and the second TRP is a cell with a different physical cell identifier (PCI) than the serving cell. The method includes receiving configuration information from a base station, the configuration information comprising enablement information configured to enable the UE to perform group-based beam reporting for both the serving cell and the cell with the different PCI, performing measurements on both the first beam and the second beam to generate measurement information and transmitting a group-based beam report to the base station, wherein the group-based beam report comprises measurement information for the cell with the different PCI.

Additional exemplary embodiments are related to a processor of a user equipment (UE) configured to receive a first beam from a first transmission and reception point (TRP) and a second beam from a second TRP, wherein the first TRP is a serving cell and the second TRP is a cell with a different physical cell identifier (PCI) than the serving cell. The processor is configured to receive configuration information from a base station, the configuration information comprising enablement information configured to enable the UE to perform group-based beam reporting for both the serving cell and the cell with the different PCI, perform measurements on both the first beam and the second beam to generate measurement information and transmit a group-based beam report to the base station, wherein the group-based beam report comprises measurement information for the cell with the different PCI.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an exemplary system diagram illustrative of a device simultaneously receiving beams from two different cells, according to some embodiments.

FIG. 5 shows an exemplary diagram illustrating two TRPs with corresponding SSBs, according to some embodiments.

FIG. 6 shows an exemplary diagram illustrating two TRPs and respective associated CSI-RS resources, according to some embodiments.

FIG. 7 shows a flow diagram illustrating an exemplary method for group-based beam reporting, according to some embodiments.

### DETAILED DESCRIPTION

The exemplary embodiments may be further understood with reference to the following description and the related appended drawings, wherein like elements are provided with the same reference numerals. The exemplary embodiments relate to beam management and multi-transmission reception point (mTRP) operation, and in particular, determining whether simultaneous multi-RX reception is feasible.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to a fifth generation (5G) New Radio (NR) network and a next generation node B (gNB). However, reference to a 5G NR network and a gNB is merely provided for illustrative purposes. The exemplary embodiments may be utilized with any appropriate type of network and base station.

The gNB may be configured with multiple transmission and reception points (TRPs). Throughout this description, a TRP generally refers to a set of components configured to transmit and/or receive a beam. In some embodiments, multiple TRPs may be deployed locally at the gNB. For example, the gNB may include multiple antenna arrays/panels that are each configured to generate a different beam. In other embodiments, multiple TRPs may be deployed at various different locations and connected to the gNB via a backhaul connection. For example, multiple small cells may be deployed at different locations and connected to the gNB. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

In addition, each gNB may support one or more cells. Throughout this description, the term “source cell” may refer to a cell operated by a source gNB. Similarly, the term “target cell” may refer to a cell operated by a target gNB. Since each gNB may support one or more cells, there may be a scenario in which multiple target cells are associated with the same target gNB. The UE may communicate with a cell over the air via a TRP. Due to the relationship between a TRP and a cell, the terms “TRP” and “cell” may be used interchangeably. For instance, in some examples, a “target cell” and a “target TRP” may be used interchangeably to generally refer to the Same connection and/or node.

Further, reference may be made to a “serving cell” and a “neighbor cell.” Those skilled in the art will understand that a serving cell generally refers to a cell that is configured to transmit data to the UE. In some examples, the terms “source cell” and “serving cell” may be used interchangeably to refer to the same node. However, in some examples, the UE may be configured with multiple serving cells and each serving cell is not required to be a source cell.

Those skilled in the art will understand that a neighbor cell generally refers to a cell that is not a serving cell for the UE but located within the vicinity of the UE and/or a serving cell. In some examples, the terms “target cell” and “neighbor cell” may be used interchangeably to generally refer to the same node. However, a neighbor cell is not required to be a target cell.

The UE may perform measurements on one or more neighbor cells using a specific downlink reference signal, e.g., a signal synchronization block (SSB) or a channel state information (CSI)-reference signal (RS), the measurements for L1/L2 based mobility may be based on SSB, CSI-RS or any other appropriate downlink resource. The measurement metric may be L1-reference signal received power (RSRP), L1-signal interference-to-noise ratio (SINR), L1-reference signal received quality (RSRQ) or any other appropriate type of metric. However, any reference to a specific type of measurement, reference signal or metric is merely provided for illustrative purposes. The exemplary embodiments may apply to any appropriate type of measurement, reference signal or metric.

The exemplary embodiments describe operations for transmitting configuration information from a base station to a user equipment (UE), wherein the UE is configured to receive a first beam from a first transmission and reception point (TRP) and a second beam from a second TRP and wherein the first TRP is a serving cell and the second TRP is a cell with a different physical cell identifier (PCI) than the serving cell. The configuration information includes enablement information configured to enable the UE to perform group-based beam reporting for both the serving cell and the cell with the different PCI. The UE is configured to perform measurements on both the first beam and the second beam to generate measurement information. A group-based beam report is transmitted from the UE and received by the base station, wherein the group-based beam report comprises measurement information for the cell with the different PCI. The group-based beam report may also include measurement information for the serving cell.

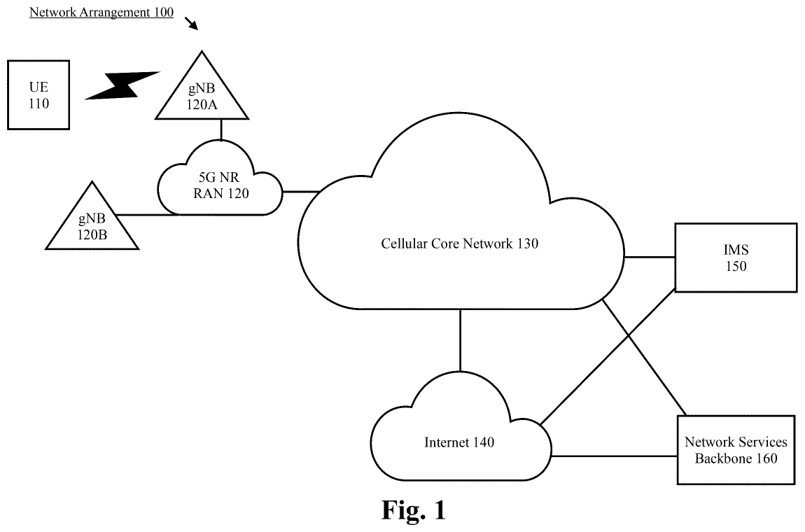

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., sixth generation (6G) RAN, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the 5G NR RAN 120 deploys a gNB 120A. The gNB 120A may be configured with multiple TRPs. Each TRP may represent one or more components configured to transmit and/or receive a signal. In some embodiments, multiple TRPs may be deployed locally at the gNB 120A. In other embodiments, multiple TRPs may be distributed at different locations and connected to the gNB 120A via a backhaul connection. For example, multiple small cells may be deployed at different locations and connected to the gNB 120A. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

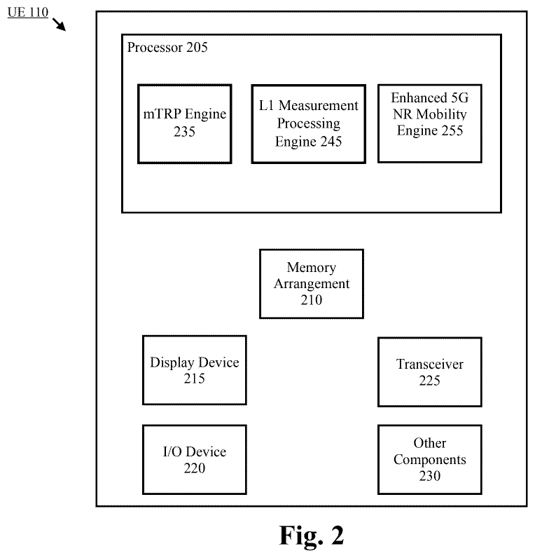

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a mTRP engine 235. The mTRP engine 235 may perform various operations related to mTRP operation. To provide some general examples, the mTRP engine 235 may perform operations such as, but not limited to, dynamically switching between mTRP mode and sTRP mode, updating a CC-group for mTRP operation and determining a default downlink beam/TCI-state for mTRP PDSCH reception.

The plurality of engines of the UE 110 may also include an L1 measurement reporting engine 245. The L1 measurement reporting engine 245 may perform operations including determining whether L1 measurements are colliding with L3 measurements. When such a collision is determined, some measurement results for RSs in a resource set may not be synchronized with measurement results for other RSs in the resource set. The L1 measurement reporting engine 245 may implement operations to, for example, omit certain measurement results from the measurement report or notify the network as to the whether some or all of the measurement results included in the measurement report are current or were determined in a previous measurement occasion.

The plurality of engines of the UE 110 may also include an enhanced 5G NR mobility engine 255. The enhanced 5G NR mobility engine 255 may perform various operations related to implementing the exemplary mobility framework described herein. These operations may include, but are not limited to, receiving configuration information, performing measurements, transmitting measurement reports, receiving DCI, receiving a MAC CE, etc.

The above referenced engines 235, 245, and 255 each being an application (e.g., a program) executed by the processor 205 is merely provided for illustrative purposes. The functionality associated with the engines 235, 245, and 255 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

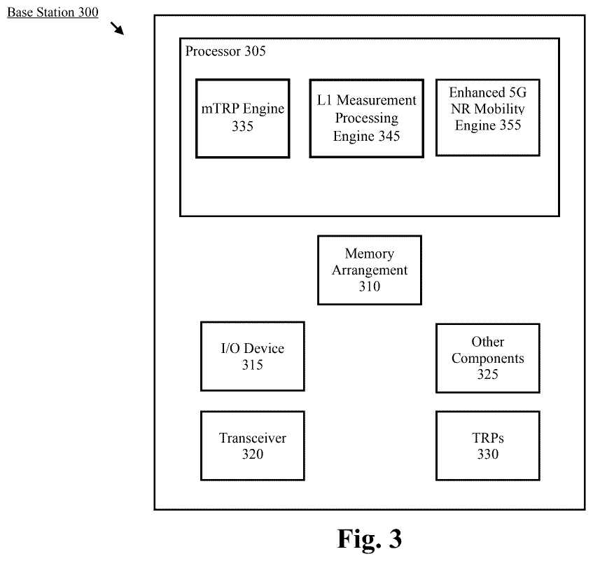

FIG. 3 shows an exemplary base station 300 according to various exemplary embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, multiple TRPs 330 and other components 325. The other components 325 may include, for example, an audio input device, an audio output device, a battery, a data acquisition device, ports to electrically connect the base station 300 to other electronic devices and/or power sources, TxRUs, transceiver chains, antenna elements, antenna panels, etc.

As indicated above, in some scenarios, the multiple TRPs 330 may be deployed locally at the base station 300. In other scenarios, one or more of the multiple TRPs 330 may be deployed at physical locations remote from the base station 300 and connected to the base station via a backhaul connection. The base station 300 may be configured to control the multiple TRPs 330 and perform operations such as, but not limited to, assigning resources, configuring reference signals, implementing beam management techniques, etc.

The processor 305 may be configured to execute a plurality of engines for the base station 300. For example, the engines may include a mTRP engine 335. The mTRP engine 335 may perform various operations related to mTRP operation. To provide some general examples, the mTRP engine 335 may perform operations such as, but not limited to, transmitting a signal to trigger the UE 110 to dynamically switch between mTRP mode and sTRP mode, transmitting information to update a CC-group for mTRP operation and indicating a default downlink beam/TCI-state for mTRP PDSCH reception.

The plurality of engines for the base station 300 may also include an L1 measurement processing engine 345. The L1 measurement reporting engine 345 may perform operations including receiving and processing measurement reports from a UE and performing beam management in reliance thereon.

The plurality of engines may include an enhanced 5G NR mobility engine 355. The enhanced 5G NR mobility engine 355 may perform various operations related to the exemplary mobility framework described herein. These operations may include, but are not limited to, transmitting a handover preparation request to another gNB, receiving capability information, transmitting configuration information, receiving measurement data, assigning resources, transmitting reference signals, transmitting DCI, transmitting a MAC CE, etc.

The above noted engines 335, 345, and 355 each being an application (e. g., a program) executed by the processor 305 is only exemplary. The functionality associated with the engines 335, 345, and 355 may also be represented as a separate incorporated component of the base station 300 or may be a modular component coupled to the base station 300, e. g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory arrangement 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UEs in the network arrangement 100. The transceiver 320 may operate on a variety of different frequencies or channels (e.g., set of consecutive frequencies). Therefore, the transceiver 320 may include one or more components to enable the data exchange with the various networks and UEs.

### Measurement and Reporting During Wireless Communications

As previously mentioned, wireless communications, such as NR cellular wireless communications, involve measurement and reporting of various channel and communication metrics. The evolution of 5G New Radio (NR) requires support for group-based beam reporting to report on multiple received beams, for example on a simultaneously received pair of beams.

In Release 18 (R18) of the 3GPP standard, a requirement for NR frequency range 2 (FR2) multi-RX chain downlink (DL) reception was formulated with certain objectives. One objective is to specify radio frequency (RF) requirements, mainly spherical coverage requirements, for devices with simultaneous reception from different directions with different quasi-co-located (QCL) TypeD reference signals (RSS). According to these requirements, the legacy spherical coverage requirements for reception from a single direction are retained. Additionally, power class 3 (PC3) is prioritized, with other power classes considered, once the PC3 requirements framework has been finalized.

Pursuant to the above, the following RRM requirements may receive consideration:
L1-RSRP measurement delay,
Layer 3 (L3) measurement delay (both cell detection delay and measurement period can be considered). The starting point is the enhancements related to L1-RSRP measurement enhancements,
Radio link monitoring (RLM) and beam failure detection/candidate beam detection (BFD/CBD) requirements,
Scheduling/measurement restrictions,
Transmission Configuration Indication (TCI) state switching delay with dual TCI, and
Receive timing difference between different directions (different QCL Type D RSs).

### Group-Based Beam Reporting on a Pair of Beams Received Simultaneously

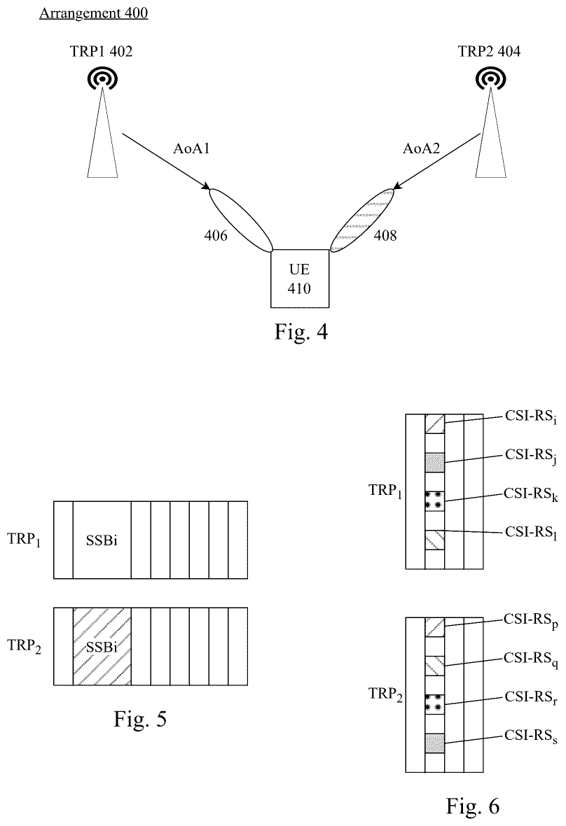

As disclosed herein, for multi-RX support, a UE may support group-based beam reporting to report on multiple received beams, for example on a pair of beams received simultaneously. FIG. 4 shows an exemplary system diagram illustrative of a UE 410 simultaneously receiving a beam 406 from a first cell 402 and a beam 408 from a second cell 404. As shown in FIG. 4, the respective angle of arrival (AoA) for each beam is different at UE 410.

The following functionality (e.g., by way of communication parameters) may thereby be implemented:
groupBeamReporting to report L1-RSRP on one (1) pair of received beams;
groupSINR-reporting-r16 to report L1-SINR on one (1) pair of received beams; and
mTRP-GroupBasedL1-RSRP-r17 to report L1-RSRP on up to four (4) pairs of received beams.

Currently, requirements are only defined for single panel reception for L1-RSRP and L1-SINR measurements. As disclosed herein, L1 measurements are enhanced to support group-based reporting for at least the following:
SSB based (simultaneous) L1-RSRP measurements,
CSI-RS based (simultaneous) L1-RSRP measurements, and
CSI-RS based (simultaneous) L1-SINR measurements.

### SSB Based Measurement—L1-RSRP

SSB Based L1-RSRP measurement(s) for single RX are currently defined for a serving cell, and for a cell with a different PCI than the serving cell (for inter-cell beam management). For multi-RX reception, for example with simultaneous beam reception, requirements may be defined for:
1. simultaneous reception from a serving cell and a cell with a different PCI (than the serving cell); and
2. simultaneous reception and L1-RSRP of two (2) SSBs from a serving cell and a cell with different PCI (than the serving cell).

Regarding (1) above, SSBs from the same cell with the same index may not be transmitted from different transmission and reception points (TRPs), and each SSB index may be associated with a TX beam. Regarding (2) above, there are currently sharing factors/resource sharing between the serving cell and a cell with a different PCI (than the serving cell), for overlapping SSBs. With simultaneous reception, the UE may measure both simultaneously, with no sharing factor or resource sharing required. FIG. 5 shows an exemplary diagram illustrating two TRPs with corresponding SSBs. The UE may simultaneously receive the respective SSBs from TRP1 and TRP2 and measure both simultaneously to obtain the L1-RSRP measurements.

### CSI-RS Based Measurement—L1 RSRP

Support may also be provided for CSI-RS based measurements with multi-RX chains. In some embodiments, two sets of resources may be configured for each TRP/AoA (Angle of Arrival). For example, a number (N) of resources may be defined per set, and/or the UE may take measurements for a pair of resources simultaneously. As an example, for the measurement of one resource (single TRP), the UE may acquire 8*T_{CSI-RS} Samples for beam refinement. Accordingly, for measurement on one pair of non-overlapping resources, with simultaneous measurement, the UE may acquire 8*T_{CSI-RS} Samples for beam refinement.

FIG. 6 shows an exemplary diagram illustrating two TRPs, TRP1 and TRP2, and respective associated four pairs of overlapping CSI-RS resources (CSI-RSᵢ to CSI-RSⱼ and CSI-RSₚ to CSI-RSₛ, respectively). For two overlapping resources per set, the UE may measure on four pairs of resources, and if all resources are overlapping, the UE may acquire 4*8*T_{CSI-RS} samples for beam refinement/measurement. In general, for N overlapping resources on two sets, the UE may measure N² pairs of resources, acquiring N*N*8*T_{CSI-RS} samples for beam refinement/measurement.

### CSI-RS Based Measurement—L1 SINR

CSI-RS based L1-SINR measurements may be defined for at least two configurations, (1) CSI-RS based channel measurement resource (CMR) with no dedicated interference measurement resource (IMR) and (2) CSI-RS based CMR with dedicated IMR. For (1), both signal and interference may be measured on the same resource. For (2), the signal and interference may be measured on different resources.

In some embodiments, group-based L1-SINR reporting may be supported for one pair of resources. The current requirements may be applicable, with the UE supporting multi-RX chain measurements on a pair of resources, for example supporting simultaneous measurements over multi-RX chains. Accordingly, the UE may acquire 8*T_{CSI-RS} samples for beam refinement for measurement on one pair of resources.

Group-based beam reporting may be extended to up to ‘N’ resources for multi-RX chain/multi-TRP measurements. For measurements on one pair of non-overlapping resources, e. g., when simulations measurements are performed, the UE may acquire 8*T_{CSI-RS} samples for beam refinement. For two overlapping resources per set, the UE may measure on four pairs of resources. If all resources are overlapping, 4*8*T_{CSI-RS} samples may be acquired for beam refinement/measurement. For N overlapping resources on two sets, the UE may measure N² pairs of resources, acquiring N*N*8*T_{CSI-RS} samples for beam refinement/measurement.

### Group-Based Beam Reporting With Multi-RX Reception and Inter-Cell Beam Management

In Release 15 (R15) of the 3GPP standard, RAN1 introduced group-based beam reporting. This was for situation where there was a single pair of resources. In Release 17 (R17) of the 3GPP standard, RAN1 enhanced group-based reporting for up to four pairs of resources, and introduced inter-cell based beam management, where a user equipment (UE) may measure and report L1 Reference Signal Receive Power (L1-RSRP) measurements for a cell with a different or additional physical cell ID (PCI). L1-RSRP measurement on a cell with a different PCI may be enabled to support with L1 based beam indication to an additional or different PCI. In this situation, the UE does not receive data simultaneously from the serving cell and the cell with the additional or different PCI. L1-RSRP measurement on a cell with a different PCI may be enabled to support inter-cell multi-TRP operation. In this situation, the UE may receive data simultaneously from the serving cell and the cell with the additional or different PCI.

Currently, group-based beam reporting is only for the serving cell. In particular, in R17, the inter-cell L1-RSRP report is not for group-based reporting. However, in inter-cell based beam management, a user equipment (UE) may measure and report L1 Reference Signal Receive Power (L1-RSRP) measurements for a cell with a different or additional physical cell ID (PCI). However, in the situation where there is both multi-RX reception and inter-cell beam management, the UE may have to deal with both the serving cell and the cell with the additional or different PCI. Thus, in exemplary embodiments described herein, group-based reporting is enabled for resource(s) from a cell with a different or additional PCI.

That is, in the present disclosure, group-based L1-RSRP reporting and L1-SINR reporting is extended to cells with a different PCI or an additional PCI, even in situations of multi-RX reception and inter-cell beam management. Implementing group-based reporting for both the serving cell and a cell with a different or additional PCI may have several benefits. For example, a base station, such as gNB 120A described herein, can configure multiple pairs of resources between the serving cell and the cell with the different or additional PCI for group based L1-RSRP reporting. In addition, the gNB may be aware of the best pairs of beams from the serving cell and the cell with the different or additional PCI. Further, based on the best L1-RSRP report, the gNB could schedule PDSCH with the corresponding transmit beams. Moreover, group-based beam reporting can enable the network to determine if simultaneous reception of SSB CSI-RS from two TRPs (or simultaneous multi-RX reception) is possible and if L1 measurement delay reduction is possible.

Thus, according to the embodiments disclosed herein, enhanced physical layer (L1) measurements with multi-RX chain (multi-receive-chain) reception may be performed on simultaneously received respective transmissions from at least two reception points (TRPs). The two TRPs may either have the same physical cell ID (PCI) or they may have different PCIs. A mobile wireless communication device (UE) may thereby support group-based beam reporting to report on a pair of received beams, including a pair of simultaneously received beams even for simultaneous multi-RX reception and inter-cell beam management.

Group-based reporting may be supported for Synchronization Signal Block (SSB) based L1 Reference Signal Receive Power (L1-RSRP) measurements, Channel State Information Reference Signal (CSI-RS) based L1-RSRP measurements, and CSI-RS based L1 Signal-To-Interference-Plus-Noise Ratio (L1-SINR) measurements. As an example, a first TRP may be a serving cell and the second TRP may be another cell, for example a neighbor cell. Accordingly, in some embodiments, the measurements may include simultaneous measurements of L1-RSRP on two Synchronization Signal Blocks (SSBs), e.g., on a first SSB received from a serving cell and a second SSB received from a second cell having a different PCI than the serving cell. The measurements may also include simultaneous measurements of L1-RSRP and/or L1-SINR on two CSI-RSS, e. g., on a first CSI-RS received from a serving cell and a second CSI-RS received from a second cell having the same PCI as the serving cell.

In addition, the group-based beam reporting may include L1-RSRP and L1-SINR reporting for both the serving cell and a cell with a different or additional PCI. In addition, if group-based beam reporting is enabled for both a serving cell and a cell with different PCI, the network can determine if measurement delay reduction is applicable or not applicable, based on a group-based report or an absence of a group-based report.

### Exemplary Method for Performing Physical Layer Measurements

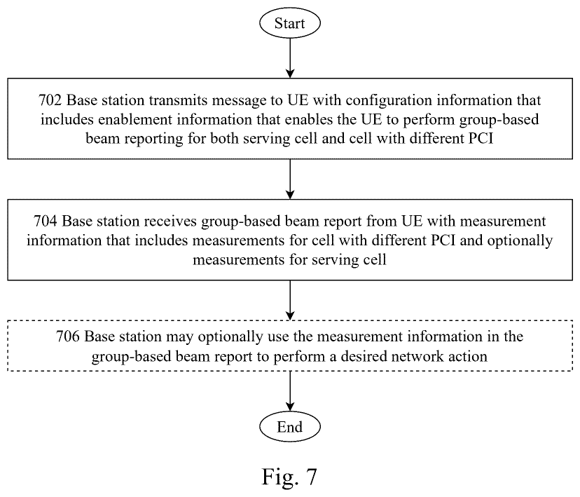

FIG. 7 shows a flow diagram illustrating an exemplary method 700 for group-based beam reporting, according to some embodiments. A base station, such as gNB 120A described herein, transmits a message with configuration information to a user equipment (UE), such as UE 110 or 410 disclosed herein (702). The UE 110 may be configured to receive a first beam from a first transmission and reception point (TRP) and a second beam from a second TRP, wherein the first TRP is a serving cell and the second TRP is a cell with a different physical cell identifier (PCI) than the serving cell. In one embodiment, the base station 120A may be triggered to transmit the message to the UE 110 in response to the UE 110 indicating to the base station 120A that it has the capability to perform group-based reporting for both serving cell and the cell with the different PCI.

The configuration information may include information to enable the UE 110 with a group-based beam reporting functionality for both the serving cell and the cell with a different PCI. In one embodiment, the configuration information may be sent as part of a CSI report configuration that includes a field in the CSI Report configuration to set the group-beam based reporting functionality for both the serving cell and the cell with a different PCI to enabled or not enabled. The configuration information may also include information indicating beam resources for multiple TRPs for which group-based beam reporting is requested. That is, the base station 120A tells the UE 110 which TRPs to measure. This information may enable the UE 110 to collect measurement data corresponding to multiple different TRPs.

In 704, the UE 110 performs the requested measurements and reports the measurements back to the base station. The reporting of the measurements is via group-based beam reporting. In particular, the measurement reports sent to the base station 120A will include a group-based beam report with the measurements for the cell with the different PCI. In some examples, the group-based beam report will also include measurements for the serving cell. The measurements performed by the UE 110 may include L1 measurements on beams from the requested TRPs. In one embodiment, the L1 measurements may be performed simultaneously on beams from two different TRPs. The L1 measurements may include SSB based L1-RSRP measurements, CSI-RS based L1-RSRP measurements, and/or CSI-RS based L1-SINR measurements.

The base station 120A may then optionally use the group-based beam reporting to perform desired network actions (706). For example, the base station 120A can configure multiple pairs of resources between the serving cell and the cell with the different or additional PCI for group based L1-RSRP reporting. In addition, based on the best measurement information in the group-based beam report, the gNB 120A may be aware of the best pairs of beams from the serving cell and the cell with the different or additional PCI. Further, based on the best report (such as L1-RSRP report), the gNB 120A may schedule PDSCH with the corresponding transmit beams. Moreover, group-based beam reporting can enable the network to determine if simultaneous reception of SSB CSI-RS from two TRPs (or simultaneous multi-RX reception) is possible and/or if L1 measurement delay reduction is possible.

### EXAMPLES

In a first example, a processor of a base station is configured to transmit configuration information to a user equipment (UE), wherein the UE is configured to receive a first beam from a first transmission and reception point (TRP) and a second beam from a second TRP, and wherein the first TRP is a serving cell and the second TRP is a cell with a different physical cell identifier (PCI) than the serving cell, the configuration information comprising enablement information configured to enable the UE to perform group-based beam reporting for both the serving cell and the cell with the different PCI and receive a group-based beam report from the UE, wherein the group-based beam report comprises measurement information for the cell with the different PCI.

In a second example, the processor of the first example, wherein the measurement information received in the group-based beam report comprises physical layer (L1) measurements including one or more of (a) L1 reference signal received power (L1-RSRP) measurements based on respective synchronization signal blocks (SSBs) associated with the first beam and the second beam, (b) L1-RSRP measurements based on respective channel state information reference signals (CSI-RSs) associated with the first beam and the second beam or (c) L1 signal-to-interference-plus-noise ratio (L1-SINR) measurements based on respective channel state information reference signals (CSI-RSs) associated with the first beam and the second beam.

In a third example, the processor of the first example, wherein the group-based beam report further comprises measurement information for the serving cell.

In a fourth example, the processor of the third example, wherein the measurement information received in the group-based beam report comprises physical layer (L1) measurements including one or more of (a) L1 reference signal received power (L1-RSRP) measurements based on respective synchronization signal blocks (SSBs) associated with the first beam and the second beam, (b) L1-RSRP measurements based on respective channel state information reference signals (CSI-RSs) associated with the first beam and the second beam or (c) L1 signal-to-interference-plus-noise ratio (L1-SINR) measurements based on respective channel state information reference signals (CSI-RSs) associated with the first beam and the second beam.

In a fifth example, the processor of the first example, wherein the configuration information further comprises information related to beam resources for multiple TRPs for which group-based beam reporting is requested, the information related to the beam resources to be used by the UE in performing measurements.

In a sixth example, the processor of the first example, wherein the configuration information is transmitted to the UE as part of a Channel State Information (CSI) Report that includes a field configured to set the group-based beam reporting functionality for both the serving cell and the cell with the different PCI to an enabled state.

In a seventh example, the processor of the first example, wherein the transmitting of the configuration information occurs in response to the UE indicating to the base station that the UE has a capability to perform group-based reporting for both the serving cell and the cell with the different PCI.

In an eighth example, the processor of the first example, further comprising performing, at the base station, a network action based on measurement information in the group-based beam report.

In a ninth example, the processor of the eighth example, wherein the network action comprises configuring multiple pairs of resources between the serving cell and the cell with the different PCI for group-based reporting.

In a tenth example, the processor of the eighth example, wherein the network action comprises identifying, based on the measurement information in the group-based beam report, which pairs of beams from the serving cell and the cell with the different PCI offer the best performance.

In an eleventh example, the processor of the tenth example, wherein the network action comprises scheduling a physical downlink shared channel (PDSCH) with the identified transmit beams.

In a twelfth example, the processor of the eighth example, wherein the network action comprises determining, based on the measurement information in the group-based beam report, whether simultaneous reception of signals from the first TRP and the second TRP is possible.

In a thirteenth example, the processor of the eighth example, wherein the network action comprises determining, based on the measurement information in the group-based beam report, whether a measurement delay reduction is possible.

In a fourteenth example, a base station comprising a transceiver configured to communicate with a user equipment (UE) and the processor of any of the first through thirteenth examples communicatively coupled to the transceiver.

In a fifteenth example, a processor of a user equipment (UE) configured to receive a first beam from a first transmission and reception point (TRP) and a second beam from a second TRP, wherein the first TRP is a serving cell and the second TRP is a cell with a different physical cell identifier (PCI) than the serving cell, the processor configured to receive configuration information from a base station, the configuration information comprising enablement information configured to enable the UE to perform group-based beam reporting for both the serving cell and the cell with the different PCI, perform measurements on both the first beam and the second beam to generate measurement information and transmit a group-based beam report to the base station, wherein the group-based beam report comprises measurement information for the cell with the different PCI.

In a sixteenth example, the processor of the fifteenth example, wherein the measurements performed by the UE and included in the group-based beam report comprise physical layer (L1) measurements including one or more of (a) L1 reference signal received power (L1-RSRP) measurements based on respective synchronization signal blocks (SSBs) associated with the first beam and the second beam, (b) L1-RSRP measurements based on respective channel state information reference signals (CSI-RSs) associated with the first beam and the second beam or (c) L1 signal-to-interference-plus-noise ratio (L1-SINR) measurements based on respective channel state information reference signals (CSI-RSs) associated with the first beam and the second beam.

In a seventeenth example, the processor of the fifteenth example, wherein the group-based beam report further comprises measurement information for the serving cell.

In an eighteenth example, the processor of the seventeenth example, wherein the measurements performed by the UE and included in the group-based beam report comprise physical layer (L1) measurements including one or more of (a) L1 reference signal received power (L1-RSRP) measurements based on respective synchronization signal blocks (SSBs) associated with the first beam and the second beam, (b) L1-RSRP measurements based on respective channel state information reference signals (CSI-RSs) associated with the first beam and the second beam or (c) L1 signal-to-interference-plus-noise ratio (L1-SINR) measurements based on respective channel state information reference signals (CSI-RSs) associated with the first beam and the second beam.

In a nineteenth example, the processor of the fifteenth example, wherein the configuration information further comprises information related to beam resources for multiple TRPs for which group-based beam reporting is requested, the information related to the beam resources to be used by the UE in performing the measurements.

In a twentieth example, the processor of the fifteenth example, wherein the configuration information received by the UE is part of a Channel State Information (CSI) Report that includes a field configured to set the group-based beam reporting functionality for both the serving cell and the cell with the different PCI to an enabled state.

In a twenty first example, the processor of the fifteenth example, further configured to transmit, prior to the receiving of the configuration information, an indication to the base station indicating that the UE has a capability to perform group-based reporting for both the serving cell and the cell with the different PCI.

In a twenty second example, a user equipment (UE) comprising a transceiver configured to communicate with a network and the processor of any of the fifteenth through twenty first examples communicatively coupled to the transceiver.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICS. In other embodiments, the present invention may be realized using one or more programmable hardware elements such as FPGAS.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method for wireless communications, the method comprising:
at a base station:
transmitting configuration information to a user equipment (UE), wherein the UE is configured to receive a first beam from a first transmission and reception point (TRP) and a second beam from a second TRP, and wherein the first TRP is a serving cell and the second TRP is a cell with a different physical cell identifier (PCI) than the serving cell, the configuration information comprising enablement information configured to enable the UE to perform group-based beam reporting for both the serving cell and the cell with the different PCI; and
receiving a group-based beam report from the UE, wherein the group-based beam report comprises measurement information for the cell with the different PCI.

2. The method of claim 1, wherein the measurement information received in the group-based beam report comprises physical layer (L1) measurements including one or more of:
(a) L1 reference signal received power (L1-RSRP) measurements based on respective synchronization signal blocks (SSBs) associated with the first beam and the second beam;
(b) L1-RSRP measurements based on respective channel state information reference signals (CSI-RSs) associated with the first beam and the second beam; or (c) L1 signal-to-interference-plus-noise ratio (L1-SINR) measurements based on respective channel state information reference signals (CSI-RSs) associated with the first beam and the second beam.

3. The method of claim 1, wherein the group-based beam report further comprises measurement information for the serving cell.

4. The method of claim 3, wherein the measurement information received in the group-based beam report comprises physical layer (L1) measurements including one or more of:
(a) L1 reference signal received power (L1-RSRP) measurements based on respective synchronization signal blocks (SSBs) associated with the first beam and the second beam;
(b) L1-RSRP measurements based on respective channel state information reference signals (CSI-RSs) associated with the first beam and the second beam; or
(c) L1 signal-to-interference-plus-noise ratio (L1-SINR) measurements based on respective channel state information reference signals (CSI-RSs) associated with the first beam and the second beam.

5. The method of claim 1, wherein the configuration information further comprises information related to beam resources for multiple TRPs for which group-based beam reporting is requested, the information related to the beam resources to be used by the UE in performing measurements.

6. The method of claim 1, wherein the configuration information is transmitted to the UE as part of a Channel State Information (CSI) Report that includes a field configured to set the group-based beam reporting functionality for both the serving cell and the cell with the different PCI to an enabled state.

7. The method of claim 1, wherein the transmitting of the configuration information occurs in response to the UE indicating to the base station that the UE has a capability to perform group-based reporting for both the serving cell and the cell with the different PCI.

8. The method of claim 1, further comprising performing, at the base station, a network action based on measurement information in the group-based beam report.

9. The method of claim 8, wherein the network action comprises configuring multiple pairs of resources between the serving cell and the cell with the different PCI for group-based reporting.

10. The method of claim 8, wherein the network action comprises identifying, based on the measurement information in the group-based beam report, which pairs of beams from the serving cell and the cell with the different PCI offer the best performance.

11. The method of claim 10, wherein the network action comprises scheduling a physical downlink shared channel (PDSCH) with the identified transmit beams.

12. The method of claim 8, wherein the network action comprises determining, based on the measurement information in the group-based beam report, whether simultaneous reception of signals from the first TRP and the second TRP is possible.

13. The method of claim 8, wherein the network action comprises determining, based on the measurement information in the group-based beam report, whether a measurement delay reduction is possible.

14. A method for wireless communications, the method comprising:
at a user equipment (UE) configured to receive a first beam from a first transmission and reception point (TRP) and a second beam from a second TRP, wherein the first TRP is a serving cell and the second TRP is a cell with a different physical cell identifier (PCI) than the serving cell:
receiving configuration information from a base station, the configuration information comprising enablement information configured to enable the UE to perform group-based beam reporting for both the serving cell and the cell with the different PCI;
performing measurements on both the first beam and the second beam to generate measurement information; and
transmitting a group-based beam report to the base station, wherein the group-based beam report comprises measurement information for the cell with the different PCI.

15. The method of claim 14, wherein the measurements performed by the UE and included in the group-based beam report comprise physical layer (L1) measurements including one or more of:
(a) L1 reference signal received power (L1-RSRP) measurements based on respective synchronization signal blocks (SSBs) associated with the first beam and the second beam;
(b) L1-RSRP measurements based on respective channel state information reference signals (CSI-RSs) associated with the first beam and the second beam; or (c) L1 signal-to-interference-plus-noise ratio (L1-SINR) measurements based on respective channel state information reference signals (CSI-RSs) associated with the first beam and the second beam.

16. The method of claim 14, wherein the group-based beam report further comprises measurement information for the serving cell.

17. The method of claim 16, wherein the measurements performed by the UE and included in the group-based beam report comprise physical layer (L1) measurements including one or more of:
(a) L1 reference signal received power (L1-RSRP) measurements based on respective synchronization signal blocks (SSBs) associated with the first beam and the second beam;
(b) L1-RSRP measurements based on respective channel state information reference signals (CSI-RSs) associated with the first beam and the second beam; or
(c) L1 signal-to-interference-plus-noise ratio (L1-SINR) measurements based on respective channel state information reference signals (CSI-RSs) associated with the first beam and the second beam.

18. The method of claim 14, wherein the configuration information further comprises information related to beam resources for multiple TRPs for which group-based beam reporting is requested, the information related to the beam resources to be used by the UE in performing the measurements.

19. The method of claim 14, wherein the configuration information received by the UE is part of a Channel State Information (CSI) Report that includes a field configured to set the group-based beam reporting functionality for both the serving cell and the cell with the different PCI to an enabled state.

20. The method of claim 14, further comprising transmitting, prior to the receiving of the configuration information, an indication to the base station indicating that the UE has a capability to perform group-based reporting for both the serving cell and the cell with the different PCI.
